(19) United States
(12) Patent Application Publication
(10) Pub. No.: US 2015/0382098 A1
(43) Pub. Date: Dec. 31, 2015

(54) PROXIMITY EAR BUDS FOR EARPHONE LISTENING

(71) Applicant: James Aita, Minot, ND (US)

(72) Inventor: James Aita, Minot, ND (US)

(21) Appl. No.: 14/315,004

(22) Filed: Jun. 25, 2014

(51) Int. Cl. H04R 1/10

(52) U.S. Cl. CPC H04R 1/1091; H04R 1/1033

(57) ABSTRACT

A set of earphones for listening to audio including: a first ear bud; a second ear bud; a first proximity sensor on the first ear bud; a second proximity sensor on the second ear bud, wherein the first proximity sensor and second proximity sensor detect placement of each respective ear bud into a user's ear and each proximity sensor activates and deactivates a audio player based upon placement of each ear bud; a first connectivity cord, extending from the first ear bud; and a second connectivity cord, extending from the second ear bud.

### BACKGROUND OF THE INVENTION

1. Field of Invention

The present invention relates to earphones that include ear buds with proximity sensors that effectively detect the position of the ear bud and control the play of audio through the earphones.

2. Description of Related Art

Earphones are generally used to listen to audio from various sources. Earphones are typically in the form of small ear buds or alternatively more complex headphone headsets. Either device provides essentially a small speaker that fits either into the opening of the ear canal in the case of the ear bud or surrounds the entire ear in the case of the larger headphones. Earphones in general provide a unique listening experience for the user. Through the use of the earphones, the user is able to listen to audio, in most cases music, without disturbing or at least sharing the listening experience with others within the surrounding area. Earphones are also used for cellular phones and desktop computers and other listening devices.

The normal earphone bud inserts into the opening of the user's ear canal and provides somewhat adequate listening capability for the user. The over ear headphones have larger circumferences so that the earphone covers the entire ear and thus may reduce outside noise interference for the listening pleasure of the user. Normally headphones or ear buds are taken away from the ears so that the user may hear something outside of the audio files or communicate with another individual. When the headphones or ear buds are removed temporarily, the audio files may continue to play. It would therefore be advantageous to have a sensor implemented within the earphones to detect movement of the earphones away from the user's ear. The sensors may be integrated with the audio player and pause the audio file until the earphone is placed back into the ear.

### SUMMARY OF THE INVENTION

The present invention relates to a set of earphones for listening to audio comprising: a first ear bud; a second ear bud; a first proximity sensor on the first ear bud; a second proximity sensor on the second ear bud, wherein the first proximity sensor and second proximity sensor detect placement of each respective ear bud into a user's ear and each proximity sensor activates and deactivates a audio player based upon placement of each ear bud; a first connectivity cord, extending from the first ear bud; and a second connectivity cord, extending from the second ear bud. The set of earphones may further include a first ear bud arm supporting the first ear bud and a second ear bud arm supporting the second ear bud. In one particular embodiment, each proximity sensor is set to deactivate an audio player base upon a pre-determined distance from the user's ear.

### BRIEF DESCRIPTION OF DRAWINGS

FIG. 1 depicts a set of earphones in accordance with the present invention.

### DETAILED DESCRIPTION

The present invention relates to earphones that include proximity sensors within the ear buds of each earphone. The sensors detect when the ear bud is removed from the user's ear. The sensors allow the user to simply remove the ear bud in order to pause music or other audio files that the user may be listening to while using the earphones. Once paused, the music is then restarted or played after replacement of the earphone into the user's ear.

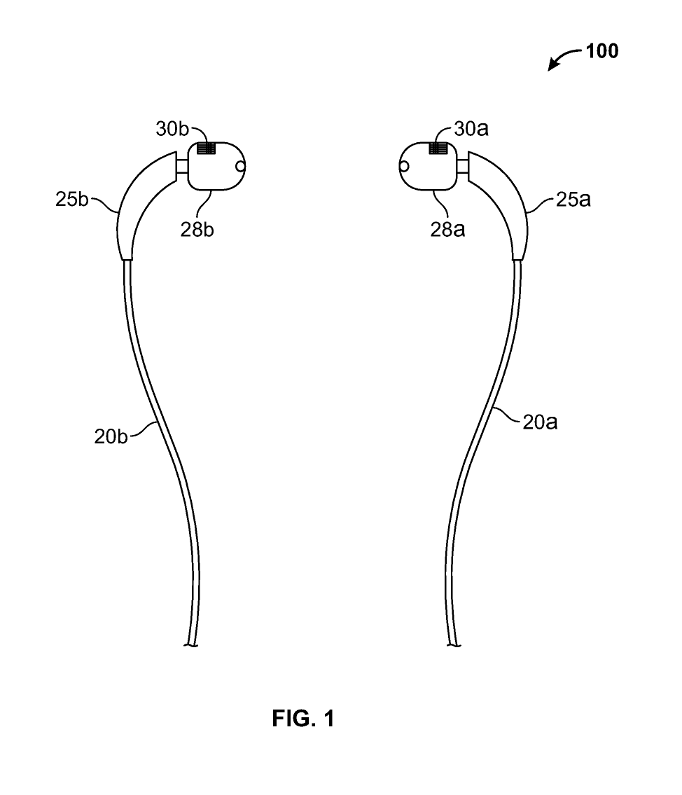

In reference to FIG. 1, a set of Earphones 100 in accordance with the present invention is depicted. The set of Earphones 100 include Ear Buds 28a, 28b. Each ear bud includes a Proximity Sensor 30a placed on Ear Bud 28a and a Proximity Sensor 30b placed on Ear Bud 28b. The Ear Buds 28a, 28b are supported by Ear Bud Arms 25a, 25b as shown in FIG. 1.

The Proximity Sensors 30a, 30b provide functionality to determine whether each respective ear bud is placed within the ear of a user. When either ear bud is removed from a user's ear, the proximity sensors activate or deactivate the playing of audio file that may be playing through the Earphones 100. This mechanism therefore allows a user to pause their audio file simply by removing the ear bud. Cords 20a, 20b are provided that connect to the Ear Buds 28a, 28b. The cords enable connectivity with the particular media player used by the user. The instant invention has been shown and described in what it considers to be the most practical and preferred embodiments. It is recognized, however, that departures may be made there from within the scope of the invention and that obvious modifications will occur to a person skilled in the art.

What is claimed is:

1. A set of earphones for listening to audio comprising:
a. a first ear bud;
b. a second ear bud;
c. a first proximity sensor on the first ear bud;
d. a second proximity sensor on the second ear bud, wherein the first proximity sensor and second proximity sensor detect placement of each respective ear bud into a user's ear and each proximity sensor activates and deactivates a audio player based upon placement of each ear bud;
e. a first connectivity cord, extending from the first ear bud; and
f. a second connectivity cord, extending from the second ear bud.

2. The set of earphones according to claim 1, further including a first ear bud arm supporting the first ear bud and a second ear bud arm supporting the second ear bud.

3. The set of earphones according to claim 1, where each proximity sensor is set to deactivate an audio player base upon a pre-determined distance from the user's ear.
